(19) United States
(12) Patent Application Publication
(10) Pub. No.: US 2021/0163860 A1
(43) Pub. Date: Jun. 3, 2021

(54) Multi-Chamber Detergent Product Having A High Contrast Between The Chambers

(71) Applicant: Henkel AG & Co. KGaA, Dusseldorf (DE)

(72) Inventors: Frank Meier, Duesseldorf (DE); Leyla Eichholz, Solingen (DE)

(21) Appl. No.: 17/103,567

(22) Filed: Nov. 24, 2020

(30) Foreign Application Priority Data
Nov. 29, 2019 (EP) 19212672

(51) Int. Cl. C11D 17/04; B65B 9/04; B65D 65/46; C11D 3/00; C11D 3/42

(52) U.S. Cl. CPC C11D 17/045; B65B 9/042; C11D 3/42; C11D 3/0084; B65D 65/46

(57) ABSTRACT

A detergent product for treating, cleaning and/or washing textiles including a film pouch having a plurality of pouch chambers, each of which is enclosed by at least one water-soluble film. The pouch chambers being formed by water-soluble films which are interconnected in a sealing plane and separated from one another by sealing portions located in the sealing plane, and the pouch chambers being filled with a detergent preparation. A plurality of pouch chambers with the number n≥2 being provided, the pouch chambers arranged in at least one sectional plane around a common n-fold axis of rotation, perpendicular to the sectional plane, and at least one central chamber which is arranged in the middle region of the film pouch and is filled with a detergent preparation. The pouch chambers being arranged around the central chamber, the detergent preparation with which the central chamber is filled being transparent and achromatic.

### FIELD OF THE INVENTION

The invention relates to a detergent product, in particular for treating textiles, more particularly for cleaning textiles and/or for washing textiles, comprising a film pouch having a plurality of pouch chambers, each of which is enclosed by a water-soluble film, the pouch chambers being formed by water-soluble films which are interconnected in a sealing plane and being separated from one another by sealing portions located in the sealing plane, and the pouch chambers each being filled with a detergent preparation, at least one central chamber being provided which is arranged in the middle region of the film pouch and is filled with a detergent preparation, and the pouch chambers being arranged around the central chamber, the detergent preparation with which the central chamber is filled being transparent and achromatic.

### BACKGROUND OF THE INVENTION

Water-soluble detergent products in the format of a disposable portion pack for treating textiles, in particular in the form of film pouches, are known. Such a portion pack is used for a single textile treatment application, usually within a textile washing machine. The detergent product has a film pouch having one or more pouch chambers. Consumer surveys and market studies show that consumers generally prefer products having multiple chambers over products having only one or fewer chambers. In general, the popularity of such multi-chamber products in the unit dosage format has increased sharply in recent years and now accounts for a considerable market share in many European countries.

A detergent preparation is accommodated in each pouch chamber of such detergent products, which preparation contains washing-active substances for treating textiles, in particular for washing textiles. The use of a plurality of pouch chambers opens up the possibility of separate storage of different detergent preparations, which under certain circumstances react chemically with one another or, if mixed, are not storage-stable for other reasons. In addition, the use of a plurality of different detergent preparations within one washing operation allows the release of a plurality of functionally different detergents and/or additives such as bleach, fabric softener or fragrances. If a plurality of pouch chambers are provided, the individual detergent preparations within the pouch chambers can have the same or different consistency and are preferably of a liquid consistency, for example liquid, gel-like, pasty, waxy, or of a solid consistency, for example powdered, granular, free-flowing or solid. The term “detergent preparation” is to be understood broadly within the meaning of the invention.

Such detergent products having a plurality of pouch chambers are known, for example, from EP 3 381 835 A1. The detergent products described therein have a high level of intrinsic dimensional stability and thus enable improved use in particular in textile washing machines, which in particular also includes improved dissolution behavior during the washing process, i.e. a high dissolution rate and largely residue-free dissolution. In addition, these detergent products can easily be manufactured inexpensively and in a resource-saving manner while having good machinability, and meet the high demands of the user for an innovative product design.

It is particularly important for the consumer that the number of chambers is easy to identify. The manufacturers therefore currently use, in the different chambers, compositions, in particular liquid detergent preparations, which can be easily distinguished from one another by strong color differences or contrasts. In particular, designs in which a chamber is filled with a white, opaque preparation scored well in consumer surveys.

However, it has been shown that the opacifiers used here are potentially disadvantageous from the point of view of environmental protection, especially against the background of microplastic particles currently under discussion.

### BRIEF SUMMARY OF THE INVENTION

On this basis, the aim of the invention is that of providing a detergent product which dispenses with the corresponding compounds without impairing user acceptance and the overall impression of the product.

It has now surprisingly been found that a multi-chamber detergent product having a central chamber which is filled with a transparent and achromatic preparation and thus itself appears transparent and colorless, still demonstrates a high contrast and the product design continues to be very appealing to the user.

In a first aspect, the invention therefore relates to a detergent product (1), in particular for treating textiles, more particularly for cleaning textiles and/or for washing textiles, comprising a film pouch (2) having a plurality of pouch chambers (3), each of which is enclosed by a water-soluble film, the pouch chambers (3) being formed by water-soluble films which are interconnected in a sealing plane and being separated from one another by sealing portions (4) located in the sealing plane, and the pouch chambers (3) each being filled with a detergent preparation, a plurality of pouch chambers (3) with the number n≥2 being provided, the pouch chambers (3) being arranged in at least one sectional plane around a common n-fold axis of rotation that is perpendicular to the sectional plane, and at least one central chamber (12) being provided which is arranged in the middle region of the film pouch (2) and is filled with a detergent preparation, and the pouch chambers (3) being arranged around the central chamber (12),

characterized in that
the detergent preparation with which the central chamber is filled is transparent and achromatic.

The detergent preparation in the central chamber and preferably also the preparations in one or more, preferably all, pouch chambers are liquid, i.e. flowable under standard conditions (20° C., 1013 mbar). “Liquid,” as used herein, also includes highly viscous liquids, liquids having a yield point and gels.

In various embodiments, the detergent preparation with which the central chamber (12) is filled has a turbidity of <50 NTU, preferably <30 NTU, more preferably <20 NTU, most preferably <10 NTU or <5 NTU. The nephelometric turbidity unit (NTU) is a unit for the turbidity of liquids that can be measured using a calibrated nephelometer. The light scattering is measured at an angle of 90° to the incident light (white light) according to EPA method 180.1 (United States Environmental Protection Agency, Revision 2.0, August 1993). Alternatively, the turbidity can also be specified in the unit FNU, which is analogous to NTU. This is determined in accordance with ISO 7027 under 90° scattered light at a wavelength of 860 nm. The turbidity measurements are preferably determined in a 30 mL glass cuvette (Hach, DE) using a laboratory turbidity meter model 2100N from Hach (Hach, USA), which carries out measurements according to USEPA method 180.1. Alternatively, the same device can also be used, but carries out measurements according to ISO 7027. Unless otherwise stated, the turbidity values stated herein are those that have been determined using the mentioned device in accordance with the USEPA 180.1 method. “Transparent,” as used herein, therefore means in particular that the preparation meets the turbidity values given above.

In various embodiments, the detergent preparation with which the central chamber (12) is filled is free of enzymes, opacifiers and/or fragrances. It is particularly preferred that they are free of opacifiers, while in various embodiments enzymes and fragrances can be contained. However, it may also be preferably for no enzymes and/or fragrances to be contained. “Free of,” as used in this context, means that the corresponding component is present in the composition in an amount <1 wt. %, preferably <0.1 wt. %, more preferably <0.01 wt. %. In particular, a component of this kind is not deliberately added. These components are in particular not contained because they can adversely affect the turbidity and thus the appearance of the formulation.

In various embodiments, the detergent preparation with which the central chamber (12) is filled contains at least one optical brightener, preferably an optical brightener of the stilbene type, preferably in an amount <1 wt. % based on the total weight of the detergent preparation in the central chamber, more preferably <0.6 wt. %.

Brighteners of the stilbene type for use in detergents are known in the prior art and include, in particular, triazinyl derivatives of 4,4′-diamino-2,2′-stilbene sulfonic acid. The economically most important stilbene derivatives are DAS1 (disodium 4,4-bis[(4-anilino-6-morpholino-1,3,5-triazin-2-yl)amino]stilbene-2,2-disulfonate) and DSBP (disodium 4,4-bis(2-sulfostyryl)biphenyl). Such compounds are commercially available, for example, under the trade name Tinopal, for example, Tinopal CBS-X (BASF).

Alternatively or additionally, the detergent preparation with which the central chamber (12) is filled can comprise at least one blue or violet dye in small amounts, for example what is referred to as a shading dye. This is contained in an amount >0 wt. %, but preferably in an amount <0.1 wt. % based on the total weight of the detergent preparation in the central chamber, more preferably <0.02 wt. %, for example between 0.001 and 0.01 wt. %. The quantities given are based on the total weight of the preparation in the central chamber. A dye of this kind is used, for example, for the purpose of masking a possible yellowish hue in the preparation. This dye, if it is used, does not change the fact that the preparation appears largely colorless when viewed with the naked eye. A suitable dye is commercially available under the name Milliken Liquitin Violet 129, for example.

In various embodiments, the detergent preparation with which the central chamber (12) is filled contains at least one antioxidant or color stabilizer. This is contained in an amount >0 wt. %, but preferably in an amount <0.5 wt. % based on the total weight of the detergent preparation in the central chamber, even more preferably <0.3 wt. %, for example between 0.05 and 0.15 wt. %. The quantities given are based on the total weight of the preparation in the central chamber. Metabisulfites (pyrosulfites), in particular sodium metabisulfite (Na₂S₂O₅), are suitable, for example, without being restricted thereto.

The detergent preparation in the central chamber is colorless or achromatic. This means in particular that it does not have a yellowish color. This preferably means that the Hazen Color Index is below a value of 310, particularly preferably below 290, even more preferably below 280, most preferably below 260. For formulations without optical brighteners, the Hazen Color Index is preferably generally below 250, particularly preferably below 230, even more preferably below 200, most preferably below 180. The Hazen Color Index can be determined in accordance with DIN EN 1557:1996 (surface-active substances—colorimetric characterization of optically clear colored liquids (products) as X-, Y-, Z-transmission color values). As an instrument, a Hach Lange Lico 500 spectral colorimeter using reference beam technology (Hach, DE) and Hach Lange LZM 130 cuvettes (1 cm, disposable cuvettes) can be used which has been calibrated with deionized water (as a reference) and with certified test solutions (Addista Color). The instrument measures the XYZ transmission and automatically calculates the Hazen color values. Unless otherwise stated, the Hazen values mentioned herein are those that were determined using the device mentioned in accordance with the DIN EN 1557:1996 method within 72 hours after the formulation of the preparation and, optionally, storage at room temperature. The Hazen Color Index can increase with longer storage, for example over a period of 12 weeks or longer. When stored for 12 weeks at room temperature, the Hazen Color Index is, according to the invention, preferably below a value of 450, particularly preferably below 400, even more preferably below 350.

Additionally or alternatively, the feature “achromatic” can mean that the preparation without shading/tinting dye has an absorption <0.10, preferably <0.08, more preferably <0.06 or <0.05, when a VIS spectrum (undiluted) is measured in the range 400-800 nm, in the wavelength range >450 to 800 nm. With a shading/tinting dye, the preparation has an absorption <0.20, preferably <0.17, <0.15, <0.12 or <0.10, preferably <0.08, even more preferably <0.06 or <0.05, when a VIS spectrum (undiluted) is measured in the range 400-800 nm, in the wavelength range >450 to 800 nm. These measurements can also be carried out in accordance with DIN EN 1557: 1996 by means of a Hach Lange Lico 500 spectral colorimeter using reference beam technology (Hach, DE) and Hach Lange LZM 130 cuvettes (1 cm, disposable cuvettes), which colorimeter has been calibrated with deionized water (as a reference) and with certified test solutions (Addista Color). Unless otherwise stated, the absorption values given here are those determined using the device mentioned in accordance with the DIN EN 1557:1996 method.

The absorption of the detergent preparation of the central chamber is, in various embodiments, the same or lower than the absorption of the preparations in the pouch chambers over the entire range of visible light. This ensures that there is sufficient contrast between the different chambers.

Further components of the detergent preparation of the central chamber include, but are not limited to, organic solvents such as glycerol and/or 1,2-propanediol, anionic and/or non-ionic surfactants such as linear alkylbenzene sulfonates and fatty alcohol ethoxylates, soaps, alkali formers, bitter substances, complexing agents such as phosphonates, soil-dissolving polymers such as (modified) polyethyleneimines and polyesters of propylene glycol and terephthalates. The latter are commercially available, for example, under the trade names Sokalan® (BASF) and Texcare® (Clariant).

In general, the detergent preparations in the central chamber are preferably highly concentrated formulations having surfactant contents >35 wt. %, for example up to 75 wt. %, typically in the range 40 to 65 wt. %, in each case based on the total weight of the preparation. The surfactants can be selected, for example, from anionic, cationic, non-ionic, amphoteric and zwitterionic surfactants and soaps. The surfactants preferably are/comprise combinations of anionic and non-ionic surfactants, for example 25 to 40 wt. %, preferably 26 to 35 wt. %, anionic surfactants and 15 to 30 wt. %, preferably 18 to 28 wt. %, non-ionic surfactants, in each case based on the total weight of the preparation. In addition (to the anionic and non-ionic surfactants), the preparation can contain soaps which are not considered to be anionic surfactants within the meaning of the above disclosure and can be contained in amounts of 1 to 15 wt. %, based on the total weight of the preparation. Preferred anionic surfactants are linear alkylbenzene sulfonates, for example C9-13 alkylbenzene sulfonates, and fatty alcohol ether sulfates, in particular linear alkylbenzene sulfonates. Suitable non-ionic surfactants are alkoxylated, in particular ethoxylated, fatty alcohols and oxo alcohols, for example having 3 to 8 EO. Combinations of linear alkylbenzene sulfonates and alkoxylated fatty alcohols/oxo alcohols are generally preferred.

The detergent preparation of the central chamber is in particular low-water to water-free, i.e. the water content, based on the total weight, is typically less than 18 wt. %, usually up to 15 wt. %, for example up to 13 wt. %. The lower limit can be, for example, 0, 1, 2, 3 or 4 wt. %.

The detergent preparations with which the pouch chambers (3) are filled are preferably colored. They therefore differ from the preparation in the central chamber. The preparations in the different pouch chambers can have the same color, but are preferably colored differently. “Colored,” as used in this context, means that the preparations appear colored to the user with the naked eye. “Colored differently” thus means that the individual preparations have different colors that the consumer can recognize with the naked eye. Examples of such colors are, without limitation, green, light blue, dark blue, turquoise, and violet.

After adding the detergent products described herein to water, the film dissolves and releases the detergent preparation. The film pouch can be formed of a plurality of water-soluble films, it being possible for the water-soluble film to preferably be PVA film (polyvinyl alcohol film). The films that can be used usually consist of polyvinyl alcohol copolymers having appropriate additives such as plasticizers, water, surfactants, antioxidants, lubricants, release agents, bitter substances or salts. The film pouch can be manufactured from a water-soluble base film and a water-soluble cover film which form the boundary walls of at least one pouch chamber. The base film can be thermoformed, for example in a plastically deforming manner, to form at least one pouch chamber. The base film and the cover film are then sealed to one another or connected to one another in one or more sealing or connecting portions. The sealing portions are then located in what is referred to as a sealing plane or connecting plane of the two films.

For the detergent products, a plurality of pouch chambers with the number n≥2 or n≥3 is provided, the pouch chambers being arranged in at least one sectional plane around a common n-fold axis of rotation that is perpendicular to the sectional plane. By rotating the film pouch or the detergent product by an angle of 360°/n about the axis of rotation, the arrangement of the pouch chambers can be made congruent with itself again, based on the surfaces of the pouch chambers in the sectional plane. If the film pouch or the detergent product rotates about the axis of rotation and the arrangement of the pouch chambers, when rotated by 360°/n, remains substantially indistinguishable from the initial state, then the film pouch has an n-fold axis of rotation within the meaning of the present invention. With a threefold axis of rotation, for example, a rotation of the film pouch by an angle of 120° about the axis of rotation results in the sectional surfaces of the pouch chambers in the sectional plane being made congruent with themselves again. This creates a total of three symmetry-equivalent or substantially congruent arrangements of the pouch chambers, based on the sectional surfaces of the pouch chambers in the sectional plane.

The term “detergent product” is to be understood broadly within the meaning of the invention and in particular also includes products which are used for washing dishes in dishwashers. The term “detergent preparation” is therefore also to be understood broadly and also includes, for example, machine dishwashing detergent and rinse aid. The following explanations relating to the use of the detergent product according to the invention in textile washing machines also apply accordingly to embodiments of the detergent product according to the invention for use in dishwashers, without going into detail.

The pouch chambers can be designed in a flow-optimized manner and arranged in a flow-optimized manner relative to one another, which, when used in a textile washing machine, leads to a uniform and intensive flow around and over the pouch chambers combined with rapid and largely complete dissolution of the film material. The pouch chambers can in particular be designed such that fewer contact surfaces for laundry items, such as buttons and/or appliqués, are created. Accordingly, the detergent products according to the invention are less likely to get caught on laundry items and are thereby moved more intensively during a washing operation, so that sufficiently high contact with the water is ensured during the washing operation.

Finally, embodiments of the pouch chambers and their arrangement relative to one another which are characterized by a very compact structure are possible. The compact structure leads to reduced material consumption. Manufacturing and packaging processes are simplified.

The product design, i.e. the geometric configuration of the pouch chambers, their size and their arrangement relative to one another, can also provide very narrow sealing portions between adjacent chambers, which leads to a reduction in the dimensions of the detergent product according to the invention and thus maximum utilization of the apparatus and machine capacities of the apparatuses and machines used for producing and transporting detergent products. In addition, the external appearance of the detergent products is enhanced.

The pouch chamber can be formed by at least two, preferably only two, film layers that are sealed together in one or more sealing portions. Preferably, only adjacent and separate pouch chambers are provided and no superimposed/overlapping pouch chambers, so that the production of the film pouch is possible using only two film layers. This leads to reduced production costs and a reduced production effort. The film pouch can be manufactured from a water-soluble base film and a water-soluble cover film, which are sealingly interconnected in the sealing plane. The base film can be thermoformed in a plastically deforming manner to form pouch chambers.

The pouch chambers are separated from one another by sealing portions located in the sealing plane. The sealing portions can in particular extend non-linearly and thus ensure a desired high level of intrinsic dimensional stability of the detergent product.

The outer contour of the film pouch in the sealing plane can preferably be circular, triangular or quadrilateral. The shaping can be done for example by laser cutting or punching. Other outer contours of the film pouch are not excluded.

In a particularly preferred embodiment, the pouch chambers have the same bases in the sealing plane, which bases are arranged around a common n-fold axis of rotation that is perpendicular to the sealing plane, where n is the number of pouch chambers. When the pouch chambers are produced by plastic deformation of a base film in a thermoforming die and subsequently connected to a cover film, the shape and size of the bases are specified by the contours of the chamber cavities of the thermoforming die. “Same” within the meaning of the invention includes an identical shape and size of the bases or approximately the same shape and size of the bases, i.e. a substantially matching shape and size, such that when the film pouch is rotated n-fold about the axis of rotation, this results in substantially symmetry-equivalent appearances of the bases in the sealing plane. Within the meaning of the invention, “substantially symmetry-equivalent appearances of the bases” are present in particular when the degree of overlap of the bases of the pouch chambers after a rotation of the film pouch, starting from a 0° position in the initial state, by 360°/n, i.e. for example for a threefold axis of rotation, a rotation of the film pouch by 120°, is at least 90%, preferably at least 95%, in each case with respect to the initial state.

The film pouch can have between two and ten or between three and ten pouch chambers, preferably between three and five pouch chambers, which can have the same or different detergent preparations. Accordingly, the pouch chambers can be arranged around a three- to nine-fold axis of rotation, preferably around a three-, four- or five-fold axis of rotation. Despite the large number of chambers, the arrangement of the pouch chambers around an n-fold axis of rotation allows a compact and flow-optimized design having the advantages mentioned above.

In particular in the case of a film pouch having a circular or polygonal, for example quadrilateral or triangular, outer contour of the film pouch in the sealing plane, an n-fold axis of rotation can be provided in the center around which the pouch chambers are arranged. This allows a very compact structure of the detergent product according to the invention. Moreover, from the user's point of view, a very appealing product design can be achieved with the smallest possible surface area of sealing portions. Consumer acceptance of the use of the detergent products according to the invention is correspondingly high.

Although not mandatory, at least two pouch chambers, preferably all pouch chambers, have the same filling volume and/or the same three-dimensional shape. The term “same” includes an identical filling volume and/or an identical three-dimensional shape or also approximately the same filling volume and/or approximately the same three-dimensional shape, which allows a deviation in the filling volume of less than 20%, preferably of less than 10%, more preferably of less than 5%, and/or a non-identical, but from the user's point of view, when viewed in three dimensions, substantially matching appearance of the pouch chambers. With the same design of the pouch chambers, a high level of intrinsic stability of the film pouch can be ensured and an intensive and uniform flow around all pouch chambers can be achieved, so that said pouch chambers dissolve substantially equally quickly. Moreover, fewer contact surfaces are created in three-dimensional space on which laundry items, such as buttons or appliqués, can get caught and then unintentionally carry the film pouch along. Finally, by designing pouch chambers to be the same size, the production of the detergent product according to the invention is simplified and the production costs are reduced. The filling volume of the pouch chambers can be in the range between 1 ml and 50 ml, preferably in the range between 2 ml and 15 ml.

It is also expedient if the base of the pouch chamber located in the sealing plane is axially asymmetrical. The base is axially asymmetrical if it cannot be mapped onto itself by a vertical axis reflection on a mirror axis extending through the base. The axial asymmetry allows flow conditions to be achieved at the pouch chamber which, when the detergent product is used in a washing operation, lead to improved and more uniform dissolution of the film material. A specific arrangement of the pouch chambers relative to one another also allows a compact design of the film pouch to be achieved, it being possible to reduce the width of the sealing portions between adjacent pouch chambers. A modern product design which has unusual pouch chamber shapes and draws the user's gaze more to the pouch chambers and their contents is possible. This contributes to a high level of consumer acceptance of the detergent product according to the invention. Against this background, a preferred embodiment of the invention provides drop-shaped, leaf-shaped or yin-and-yang-shaped bases of the pouch chamber. A particularly preferred contour of the pouch chamber in the sealing plane is characterized by a narrow convex end portion and a wide convex end portion of the contour, which wide convex end portion is opposite said narrow convex end portion in the longitudinal direction of the pouch chamber. The contour can be characterized by a first circular shape that is placed on the narrow end portion and has a smaller inner radius and a second circular shape that is placed on the wider end portion and has a larger inner radius, the ratio of the larger inner radius to the smaller inner radius being more than 3:1, preferably more than 5:1, more preferably more than 8:1, or can also be more than 12:1. When the film pouch is produced in a thermoforming mold, the inner radii are specified by the cavities of the thermoforming mold. Between the narrow convex end portion and the wide convex end portion, the contour can be provided by a concave or straight inner portion directed toward the middle of the film pouch and a convex or straight outer portion directed toward the outer edge of the film pouch, resulting in a drop-shaped, leaf-shaped or yin-and-yang-shaped base of the pouch chamber.

In an advantageous embodiment of the pouch chamber contour in the sealing plane, in each case a wide convex end portion of the contour of a first pouch chamber can adjoin or face a concave or straight inner portion and/or a narrow convex end portion of the contour of an adjacent second pouch chamber. Alternatively or additionally, the narrow convex end portion of the contour of the second pouch chamber can also surround the wide convex end portion of the contour of the adjacent first pouch chamber from the outside in portions. Alternatively or additionally, the wide convex end portion of the contour of the first pouch chamber can intersect a tangent placed on the wide convex end portion and on the narrow convex end portion of the contour of the adjacent second pouch chamber. The wide convex end portion of the first pouch chamber then extends into a concave region of the contour of the second pouch chamber. The contours described above allow a product design that is characterized by a very compact arrangement of the pouch chambers on the film pouch.

In particular, the transitions of the pouch chambers in the circumferential direction of the film pouch can be characterized by narrow sealing portions. The sealing portions can have a maximum width of less than 5 mm, preferably less than 3 mm, more preferably only 2 mm or less, in particular in the radially outer regions between two adjacent pouch chambers. The detergent product can accordingly get caught on laundry items less easily. This results in intensive contact of the film pouch with the washing liquor, the laundry drum and the laundry during a washing operation, and the pouch is prevented from being carried on the wash load, resulting in improved dissolution behavior of the film pouch. Moreover, a higher level of intrinsic stability of the detergent product can be achieved in this way. From the user's point of view, this allows a modern and interesting product design due to the unusual shape of the pouch chambers, the user hardly perceiving narrow sealing portions between the pouch chambers and the user's attention being drawn to the pouch chamber and its contents.

In order to achieve as homogeneous a flow as possible around the pouch chambers and good dissolution behavior, as well as high level of intrinsic dimensional stability with the narrowest possible sealing portions between the pouch chambers, the outer portions of the contours of the pouch chambers in the sealing plane can be located at least substantially on a common circumferential line which can have a substantially circular, elliptical, superelliptical, square, rectangular or triangular shape.

It has been shown that particularly advantageous flow conditions at the pouch chambers and overall very good dissolution behavior of the film pouch can be achieved if a bisector of the base of a pouch chamber in the sealing plane is sinistral or dextral and if, preferably, a sinistral or dextral arrangement all pouch chambers is provided. The bases of all pouch chambers can have outer contours and/or inner contours having the same direction of curvature at least in portions. The bisectors of all pouch chambers of the film pouch are then curved in the same direction, i.e. either to the left or to the right, which leads to an aesthetically pleasing appearance of the detergent product according to the invention. In addition, a curvature of the pouch chambers directed in the same direction can contribute to the fact that the detergent product comes into intensive contact with the washing liquor and the laundry items in the washing drum, and the washing liquor, as it were, “moves through” without getting stuck on particular laundry items and without being carried on the wash load or even being conveyed to the porthole.

Particularly advantageous for improved dissolution behavior is a shape of the base of the pouch chamber located in the sealing plane, in which the width of the base transverse to the bisector continuously increases, starting from a narrow convex end portion of the contour of the pouch chamber in the sealing plane, initially along the bisector toward an opposite wide convex end portion of the contour, until a maximum value of the width is reached. The width can then decrease again up to the wide convex end portion. Correspondingly, the cross-sectional area of the pouch chamber perpendicular to the sealing plane, starting from the narrow convex end portion of the contour, can continuously increase along the bisector until a maximum value is reached, and then decrease again until the wide convex end portion is reached. The pouch chamber can then have a helical structure both in two-dimensional space in the sealing plane and in three-dimensional space in the direction of rotation of the bisector. Here, the cross-sectional area of the pouch chamber can initially increase over a longer portion of the bisector until the maximum value is reached and then decrease again over a shorter portion after the maximum value has been reached. The same can apply to the width of the base.

The subsequent pouch chamber having the same cross-sectional shape can then follow, the maximum cross-sectional area of a subsequent pouch chamber being equal to the maximum cross-sectional area of a preceding pouch chamber or greater or less than the maximum cross-sectional area of a preceding pouch chamber. If the contour of the pouch chamber in the sealing plane has a narrow convex end portion and a wide convex end portion opposite the narrow convex end portion, then the maximum cross section or the maximum width of the pouch chamber can be located in the region of the center of a circular arc placed from the inside on the wide convex end portion.

At least one central chamber is provided in the middle region of the film pouch, the pouch chambers being arranged around the central chamber. This optimizes the dissolution behavior of the detergent product and achieves a high level of stability against unintentional folding over of the pouch chambers when the detergent product is held.

The central chamber is separated from each pouch chamber by a sealing portion, it being possible for the central chamber to be at the same distance from each pouch chamber. The minimum width of the sealing portion between a pouch chamber and the central chamber is less than 5 mm, preferably less than 3 mm, more preferably less than 2 mm. A high level of intrinsic dimensional stability and a product design that is appealing from the user's point of view can thus be achieved.

The central chamber has a base in the sealing plane, it being possible for the base to be circularly symmetrical or n-fold rotationally symmetrical, where n is the number of pouch chambers of the film pouch. The central chamber can have a circular base or a polygonal base, preferably a square, triangular, star-shaped, propeller-shaped or fan-wheel-shaped base, for example. In the sealing plane, the central chamber can have, for example, a triangular base having convexly curved corner portions and convex and/or concave and/or wave-shaped side portions. In three-dimensional space, the central chamber can be hemispherical, for example. By having a rotationally symmetrical design of the central chamber in two-dimensional space, i.e. based on a plan view of the base of the central chamber in the sealing plane, and/or in three-dimensional space, i.e. based on a perspective view of the central chamber, the basic concept according to the invention of the arrangement of the pouch chambers around an n-fold axis of rotation has been taken into account and this basic concept has been developed to reinforce the advantages described above. The central chamber is therefore in particular designed differently and thus has a different three-dimensional shape than the other pouch chambers surrounding said central chamber.

The production process of the detergent product according to the invention and also the water-soluble films used to produce the product are known in principle to a person skilled in the art and are also described in EP 3 381 835 A1. Examples of preferred polymers, copolymers or derivatives that are suitable for use as pouch chambers, as well as suitable detergent preparations, are also described in DE 10 2014 102 567 A1. The disclosure of the aforementioned documents is hereby incorporated into the disclosure of the present description of the invention.

### BRIEF DESCRIPTION OF THE DRAWINGS

The invention is explained in more detail below using the figures by way of example. The features mentioned and described above and the features shown in the drawings and described below can be combined with one another if necessary, even if this is not shown in detail. The invention is not limited to the features and combinations of features shown in the figures, in which:

FIG. 1 is a perspective view obliquely from above of a first embodiment of a detergent product according to the invention, comprising a film pouch having three pouch chambers and, in the middle, a central chamber;

FIG. 2 is a plan view of the bases of the pouch chambers and the base of the film pouch in the sealing plane of the detergent product shown in FIG. 1;

FIG. 3 is a view from below of the bases of the pouch chambers and the base of the film pouch in the sealing plane of the detergent product shown in FIG. 1;

FIG. 4 is a side view of the detergent product shown in FIG. 1 in the viewing direction shown by I in FIG. 2;

FIG. 5 is a side view of the detergent product shown in FIG. 1 in the viewing direction shown by II in FIG. 2;

FIG. 6 is a side view of the detergent product shown in FIG. 1 in the viewing direction shown by III in FIG. 2;

FIG. 7 is a side view of the detergent product shown in FIG. 1 in the viewing direction shown by IV in FIG. 2;

FIG. 8 is a perspective view obliquely from above of a second embodiment of a detergent product according to the invention, comprising a film pouch having three pouch chambers and having a dome-like central chamber that has a triangular base in the sealing plane;

FIG. 9 is a plan view of the bases of the pouch chambers and the base of the film pouch in the sealing plane of the detergent product shown in FIG. 8;

FIG. 10 is a view from below of the bases of the pouch chambers and the base of the film pouch in the sealing plane of the detergent product shown in FIG. 8;

FIG. 11 is a side view of the detergent product shown in FIG. 8 in the viewing direction shown by I in FIG. 9;

FIG. 12 is a side view of the detergent product shown in FIG. 8 in the viewing direction shown by II in FIG. 9;

FIG. 13 is a side view of the detergent product shown in FIG. 8 in the viewing direction shown by III in FIG. 9;

FIG. 14 is a side view of the detergent product shown in FIG. 8 in the viewing direction shown by IV in FIG. 9;

FIG. 15 is a perspective view obliquely from above of a third embodiment of a detergent product according to the invention, comprising a film pouch having three pouch chambers and a dome-like central chamber that has a triangular consumed base in the sealing plane;

FIG. 16 is a plan view of the bases of the pouch chambers and the base of the film pouch in the sealing plane of the detergent product shown in FIG. 15;

FIG. 17 a view from below of the bases of the pouch chambers and the base of the film pouch in the sealing plane of the detergent product shown in FIG. 15;

FIG. 18 is a side view of the detergent product shown in FIG. 15 in the viewing direction shown by I in FIG. 16;

FIG. 19 is a side view of the detergent product shown in FIG. 15 in the viewing direction shown by II in FIG. 16;

FIG. 20 is a side view of the detergent product shown in FIG. 15 in the viewing direction shown by III in FIG. 16;

FIG. 21 is a side view of the detergent product shown in FIG. 15 in the viewing direction shown by IV in FIG. 16;

FIG. 22 is a perspective view obliquely from above of a second embodiment of a detergent product according to the invention, comprising a film pouch having two pouch chambers and, in the middle, a central chamber;

FIG. 23 is a plan view of the bases of the pouch chambers and the base of the film pouch in the sealing plane of the detergent product shown in FIG. 22; and

FIG. 24 is a side view of the detergent product shown in FIG. 22 in the viewing direction shown by I in FIG. 23.

### DETAILED DESCRIPTION OF THE INVENTION

The figures show different embodiments of detergent products 1 for treating textiles in the format of disposable portion packs. Such a portion pack is used for a single textile treatment application, usually in a textile washing machine. Each detergent product 1 has a film pouch 2 having two or three pouch chambers 3. The individual pouch chambers 3 contain detergent preparations which can contain washing-active substances for treating textiles, in particular for washing textiles. For the production of the film pouch 2, water-soluble PVA films having the type designation M8630 or M8720 from the film manufacturer Monosol can be used. Alternatively, appropriately designed water-soluble films from other film manufacturers such as Aicello, Nippon Gohsei or Mondi can also be used.

The film pouch 2 is formed from two water-soluble films which can be in the form of PVA films. The water-soluble films enclose the pouch chambers 3 by forming the boundary walls of said chambers. The films are interconnected in the region of sealing portions 4 such that the pouch chambers 3 are each completely closed and separated from one another by the sealing portions 4. A sealed film portion is also provided between two adjacent pouch chambers 3, which portion interconnects the pouch chambers 3 to achieve a single portion pack.

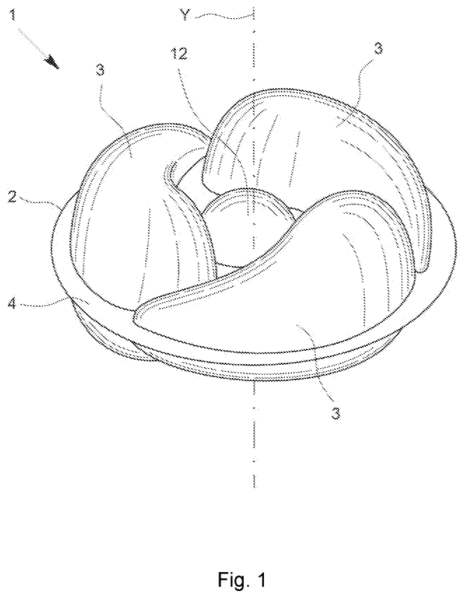

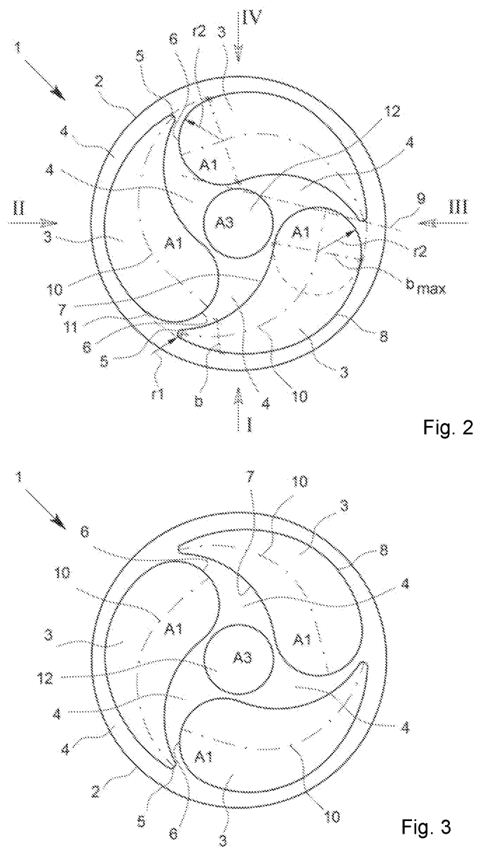

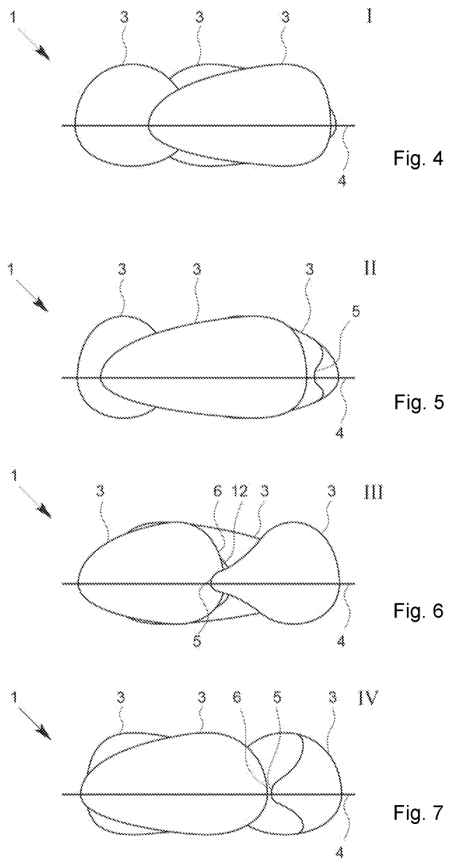

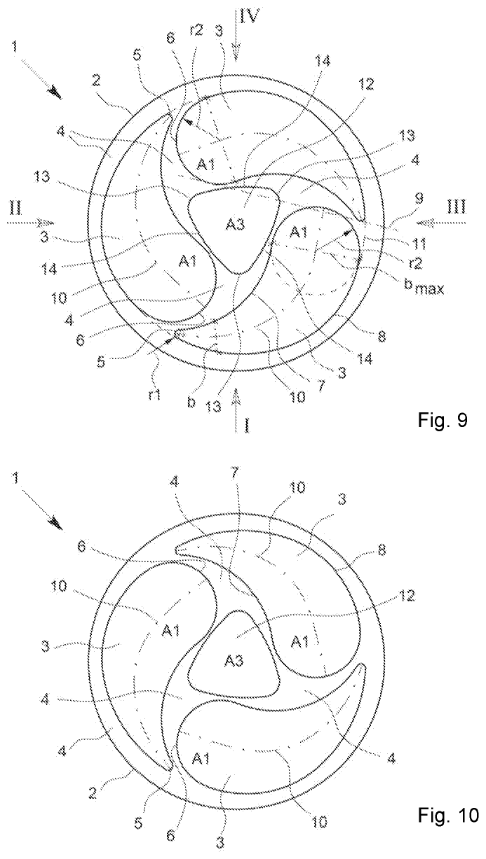

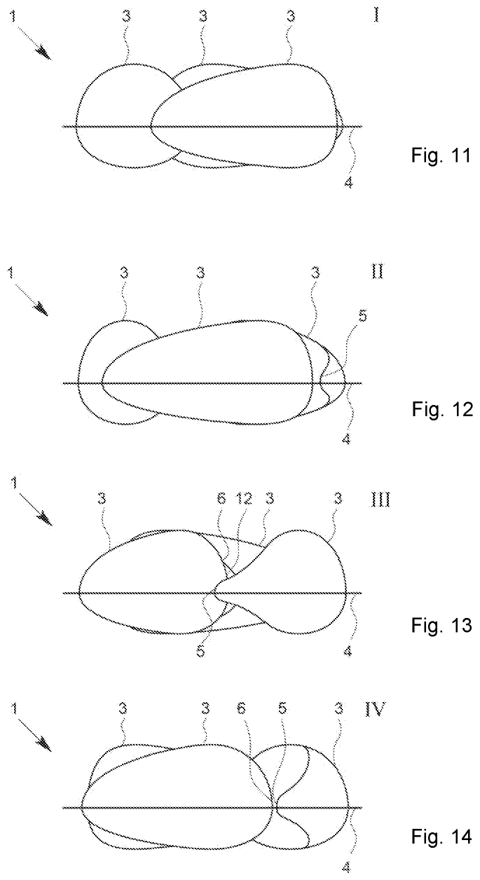

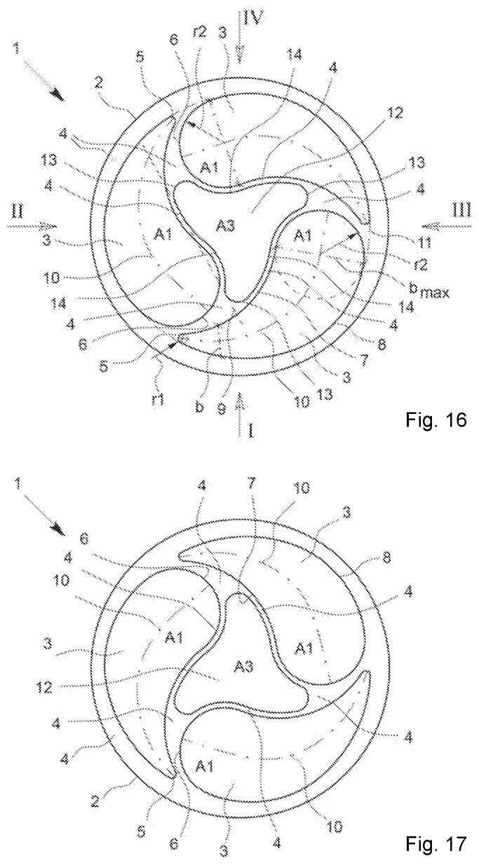

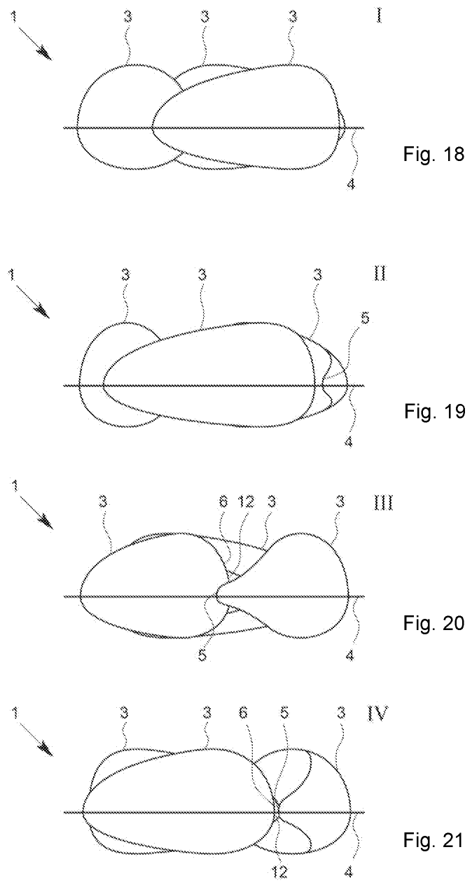

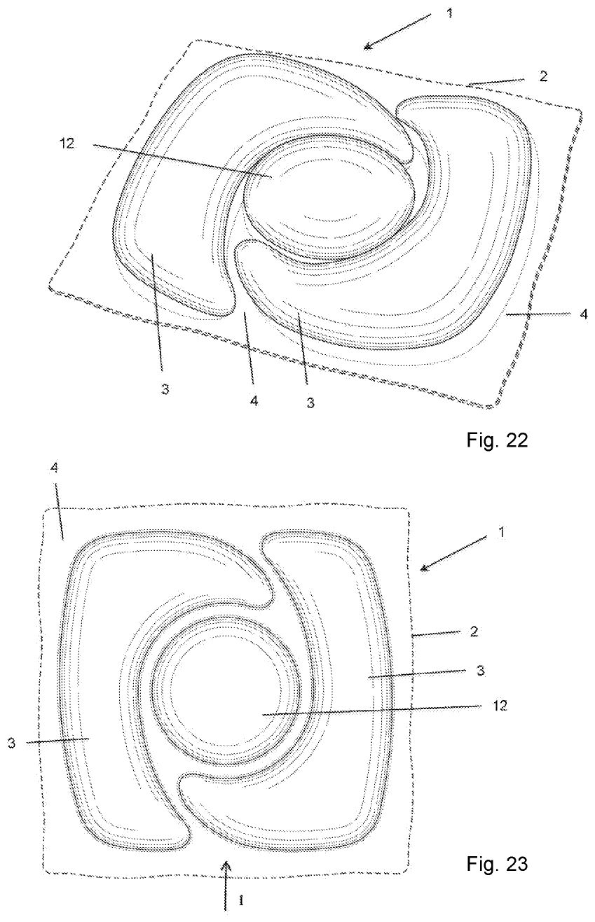

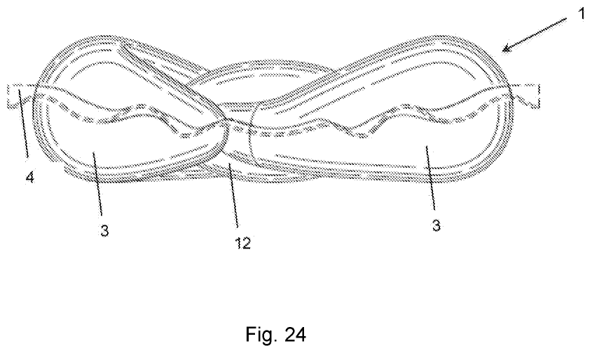

The pouch chambers 3 each have the same base A1 in the sealing plane or in the connecting plane between the films (FIG. 2, 3; 9, 10; 16, 17), while the entire detergent product 1 or the film pouch 2 has the base A2 in the sealing plane. The base A1 of a pouch chamber 3 is bounded by the contour line of the particular pouch chamber 2 in the sealing plane. The base A2 of the (entire) detergent product 1 is bounded by its contour line of the sealing plane. In the embodiments shown in FIGS. 1 to 21, a substantially circular or superelliptical base A2 of the detergent product 1 is provided, while in the embodiments shown in FIG. 22-24 a substantially square base of the detergent product is provided.

In the embodiments shown in FIG. 1-21, the bases A1 of the pouch chambers 2 each have a drop or teardrop shape having a narrow convex end portion 5 of the contour line of the particular pouch chamber 3 in the sealing plane (with a smaller inner radius r1) and having a wider convex end portion 6 that is opposite said narrow convex end portion in the longitudinal direction the pouch chamber 3 (with a larger inner radius r2). Between the two convex portions 5, 6 at the ends of the pouch chamber 3, a concave or optionally also straight connecting portion 7 is provided radially on the inside and a convex or straight connecting portion 8 is provided radially on the outside.

The different product designs of the detergent products 1 shown in FIGS. 1 to 21, i.e. in particular the geometric configuration (shape), the size and the arrangement of the pouch chambers 3 relative to one another, are explained in detail below. All the embodiments shown in these figures have the common feature that a plurality of pouch chambers 3 with the number n≥3 is provided, the pouch chambers 3 being arranged in at least one sectional plane, in this case the sealing plane, around a common n-fold axis of rotation Y (FIG. 1, 8, 15) which is perpendicular to the sectional plane. This results in a compact arrangement of the pouch chambers 3 with narrow sealing portions 4 between the pouch chambers 3 being provided so that product capacities of the apparatuses and systems used to produce the detergent product 1 can be optimally used.

The compact arrangement of the pouch chambers 3 also reduces the contact surfaces on which laundry items, such as buttons or appliqués, can get caught. If caught, the detergent product 1 can be held on the corresponding laundry item and transported around with it, so that overall the circulating movements of the detergent product 1 decrease during a washing operation in a textile washing machine and the washing liquid washes around the film pouch 2 less intensively. The restricted movement of the detergent product 1 and the washing liquid washing around the pouch less deteriorate the dissolution behavior of the water-soluble film pouch 2, specifically the dissolution rate and the degree of dissolution achieved during a washing process.

In addition, the compact arrangement of the pouch chambers 3 leads to a higher level of intrinsic stability of the film pouch 2, which increases the user's acceptance of the detergent products 1.

Improved dissolution behavior of the film pouch 3 also results from a flow-optimized configuration of the pouch chambers 3 and from a flow-optimized arrangement of the pouch chambers 3 relative to one another. In the embodiments shown, the washing liquid washes around the pouch chambers 3 in a turbulent manner during a washing operation, so that in particular the sealing portions 4 of the film pouch located between adjacent pouch chambers 3 dissolve more quickly and more completely than is the case with the detergent products 1 known from the prior art. The transitions of the pouch chambers 3 in the (radially) outer edge regions of the film pouch 2 are characterized by narrow sealing portions between adjacent pouch chambers 3, and therefore the user's gaze is directed to the pouch chambers 3 and their contents. The result is a very appealing “innovative” product design, which contributes to a high level of user acceptance.

The detergent products 1 shown in FIGS. 1 to 21 each have three pouch chambers 3 having the same bases A1 in the sealing plane, the bases A1 being arranged around a common 3-fold axis of rotation Y that is perpendicular to the sealing plane. If the film pouch 2 or the detergent product 1 rotates about the axis of rotation Y, the arrangement of the pouch chambers 3, when rotated by 120°, remains substantially indistinguishable from the initial state, resulting in a total of three symmetry-equivalent or substantially congruent arrangements of the bases A1.

In the embodiments shown in the figures, the pouch chambers 3 are arranged around a central chamber 12 in the middle region of the film pouch 2. The pouch chambers 3 are arranged one behind the other in the longitudinal direction of the pouch chambers 3 or in the circumferential direction of the base A2 of the film pouch 2 and do not overlap one another. All of the pouch chambers 3 have the same filling volume and the same three-dimensional shape. The central chamber 12 is surrounded by the pouch chambers 3. When used in a textile washing machine, the central chamber 12 leads to strong turbulence of the washing water in the middle region of the film pouch 2 between the adjacent pouch chambers 3. The central chamber 12 can thus further optimize the dissolution behavior of the film pouch 2. In principle, both the base A3 and the overall three-dimensional shape of the central chamber 12 have a different design than the pouch chambers 3 surrounding said chamber.

The base A1 is also axially asymmetrical. Each of the bases A1 can be drop-shaped. Based on a circular shape placed on the narrow convex end portion 5 of the contour of the pouch chamber 3 in the sealing plane and having a smaller inner radius r1 and a circular shape placed on the wider convex end portion 6 and having a larger inner radius r2, the ratio of the larger inner radius r2 to the smaller inner radius r1 according to FIG. 2 is approximately 5:1 or more.

As can also be seen from FIG. 2, adjacent pouch chambers 3 are arranged relative to one another such that the wider convex end portion 6 of the contour of a first pouch chamber 3 is opposite the concave connecting portion 7 of a second pouch chamber 3 following in the circumferential direction. The narrower convex end portion 5 of the subsequent second pouch chamber 3 is offset radially outward relative to the wider convex end portion 6 of the first pouch chamber 3 with respect to the bisector 10 of the two bases A1 of the adjacent pouch chambers 3. Here, the starting point of the bisector 10 of the base A1 at the narrow end of a pouch chamber 3 following in the circumferential direction of the film pouch 2 is offset radially outward relative to the end point of the bisector 10 of the base A1 at the wide end of a preceding pouch chamber 3.

The wider convex end portion 6 of the contour of a preceding pouch chamber 3 in the sealing plane also intersects a tangent 9 that is placed on the narrow convex end portion 5 and on the wide convex end portion 6 of the contour of a subsequent pouch chamber 3 and thus extends into a concave region of the subsequent pouch chamber 3.

The connecting portions 7, 8 of the contours of all the pouch chambers 3 in the sealing plane have the same direction of curvature starting from the narrow convex end portion 5 to the wide convex end portion 6 of the particular pouch chamber 3. The same applies to the bisector 10. According to FIG. 2, a sinistral arrangement of the bases A1 of the pouch chambers 3 in the direction from the narrow convex end portion 5 to the wide convex end portion 6 (or a corresponding dextral arrangement when the film pouch 2 is viewed from below according to FIG. 3). It goes without saying that a dextral arrangement of the bases A1 of the pouch chambers 3 can also be provided in a plan view.

FIG. 2 shows that the width b of the base A1 of each pouch chamber 3 transverse to the bisector 10, starting from the narrow convex end portion 5 in the direction toward the wide convex end portion 6, initially increases continuously until a maximum width is reached.

The width then decreases again continuously as far as the wide convex end portion 6. The same applies to the cross-sectional area perpendicular to the sealing plane. Here, the cross-sectional area increases starting from a narrow end of the pouch chamber 3 (cross-sectional area=0) toward a wide end of the pouch chamber 3 (cross-sectional area=0) in the longitudinal direction of the pouch chamber 3, initially over a greater length at a smaller slope, until a maximum cross-sectional area of the pouch chamber 3 is reached and, after reaching the maximum cross-sectional area, falls back to zero at the wider end of the pouch chamber 3 over a shorter length at a steeper slope. The subsequent pouch chamber 3 then follows, with the same or a similar cross-sectional shape, the maximum cross-sectional area of the subsequent pouch chamber 3 in the embodiments shown in FIGS. 1 to 21 being equal to the maximum cross-sectional area of a preceding pouch chamber 3 in each case.

The geometry of the pouch chamber 3 or of its envelope is thus characterized by a helical structure both in two-dimensional space in the sealing plane (in a plan view of the bases A1) and in three-dimensional space (in a perspective view of the pouch chambers 3) in the direction of curvature of the bisector 10.

The maximum width of a base A1 or the maximum cross-sectional area of a pouch chamber 3 can be achieved in the region of the center of a circular arc placed from the inside on the wide convex end portion 6 of the contour line of the pouch chamber 3 in the sealing plane.

It should also be noted that the convex outer connecting portions 8 of the contour lines of the pouch chambers 3 of a film pouch 2 in the detergent products 1 shown in FIGS. 1 to 21 are arranged on a common circumferential line 11 that is at least substantially circular or superelliptical. Other shapes of the circumferential line 11 are not excluded, for example the circumferential line 11 can be rectangular or square. This also contributes to a compact structure. The smallest distance between two pouch chambers 2 following in the direction of the circumferential line 11 in the sealing plane can preferably be less than 5 mm, more preferably less than 3 mm, particularly preferably less than 2 mm. Due to the deformations occurring during the production of the film pouch 2 by thermoforming and due to the restoring forces of the film layers, adjacent pouch chambers 3 can even partially abut one another when the detergent product 1 is in use.

In the embodiment shown in FIGS. 1 to 7, a spherical central chamber 12 having a circular base A3 is provided in the sealing plane (FIG. 2).

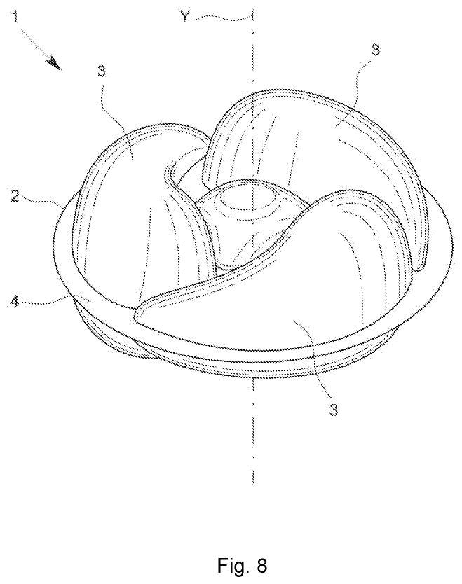

The embodiment shown in FIGS. 8 to 14 shows a central chamber 12 which forms a dome on the upper side and on the lower side of the film pouch 2 and has a triangular base A3 in the sealing plane. The base A3 is characterized by corner portions 13 which are more convexly curved and only slightly convexly curved side portions 14. In comparison with the embodiment shown in FIGS. 1 to 7, which comprises a central chamber 12 that has a circular base A3 in the sealing plane, a central chamber 12 having a triangular base A3 allows the surface area of the sealing portions 4 between the central chamber 12 and the adjacent pouch chambers 3 to be reduced further. The user perceives the sealing portions 4 between the central chamber 12 and the pouch chambers 3 less, which contributes to an attractive aesthetic appearance of the detergent product 1 and directs the interest of the user even more to the pouch chambers 3 and the detergent preparations contained therein.

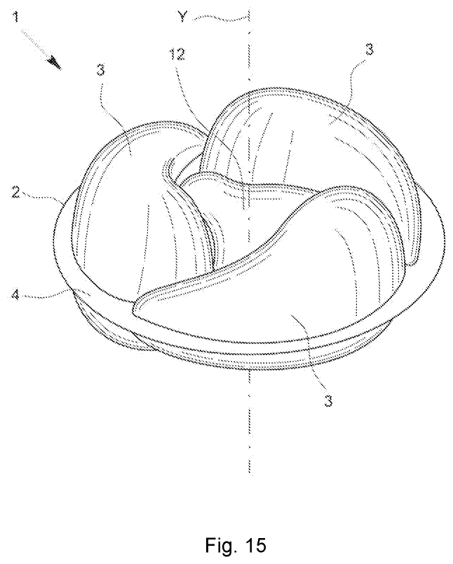

The embodiment shown in FIGS. 15 to 21 has a central chamber 12 having a base A3, the contour of which is adapted even more closely to the contour of the adjacent pouch chambers 3. This leads to substantial minimization of the size of the sealing surfaces in the middle region of the film pouch 2 between the pouch chambers 3. The base A3 of the central chamber 12 has approximately the shape of a distorted triangle having convex corner portions 13 and S-shaped or wave-shaped side portions 14 therebetween. Over the course of the side portions 14, the minimum distance between the base A3 of the central chamber 12 and the bases A1 of the adjacent pouch chambers 3 remains substantially constant.

In the embodiments shown in FIGS. 8 to 21, the bases A3 of the central chambers 12 are each designed and/or arranged with three-fold rotational symmetry.

The detergent products 1 shown in FIG. 22-24 each have two pouch chambers 3 having the same bases in the sealing plane.

### LIST OF REFERENCE SIGNS

1 Detergent product
2 Film pouch
3 Pouch chamber
4 Sealing portion
5 End portion
6 End portion
7 Connecting portion
8 Connecting portion
9 Tangent
10 Bisector
11 Circumferential line
12 Central chamber
13 Corner portion
14 Side portion
15 Arrow

### EXAMPLES

### Example 1: Production of Water-Soluble Portion Pouches

Production of a four-chamber portion pouch using the film Kuraray Monosol M8720, 88 μm film thickness in a four-chamber cavity (thermoforming temperature 102° C., sealing temperature 150° C.). In each case, 7.5 g of formulations 1 to 3 were packaged in a chamber 1 to 3 and 2.5 g of formulation 4 was packaged in the central chamber (table 1: universal detergent; table 2: color detergent). Total weight of liquids: 25 g. For both formulations 4, NTU, Hazen and absorption in the range 450-800 nm were determined using the methods given above.

NTU: Light scattering was determined at an angle of 90° to the incident light (white light) according to EPA method 180.1 (United States Environmental Protection Agency, Revision 2.0, August 1993) using a laboratory turbidity meter model 2100N from Hach (Hach, USA) in a 30 mL glass cuvette (Hach, DE).

Hazen: The Hazen color index was determined in accordance with DIN EN 1557:1996 (surface-active substances—colorimetric characterization of optically clear, colored liquids (products) as X-, Y-, Z-transmission color values) by means of a Hach Lange Lico 500 spectral colorimeter using reference beam technology (Hach, DE) and Hach Lange LZM 130 cuvettes (1 cm, disposable cuvettes), which colorimeter has been calibrated with deionized water (as a reference) and with certified test solutions (Addista Color). The samples were previously stored for 3 weeks at room temperature.

Absorption: Determined according to DIN EN 1557: 1996 by means of a Hach Lange Lico 500 spectral colorimeter using reference beam technology (Hach, DE) and Hach Lange LZM 130 cuvettes (1 cm, disposable cuvettes), which colorimeter has been calibrated with deionized water (as a reference) and with certified test solutions (Addista Color).

TABLE 1
Formulations (all quantities in wt. % based on total weight)

| Ingredient | Form. 1 | Form. 2 | Form. 3 | Form. 4 |
|---|---|---|---|---|
| Propylene glycol | 6.6 | 7.2 | 6.1 | 6.8 |
| Glycerol | 10.2 | 9.1 | 12.0 | 11.7 |
| Optical brightener | 0.6 | 0.7 | 0.4 | 0.5 |
| (stilbene type) | | | | |
| Linear alkylbenzene | 23.1 | 21.9 | 25.4 | 23.5 |
| sulfonate | | | | |
| C13/15 oxo alcohol | 23.2 | 25.2 | 21.6 | 25.2 |
| having 8 EO | | | | |
| Monoethanolamine for | 6.1 | 6.8 | 6.7 | 6.5 |
| saponification | | | | |
| C12-18 soap | 8.4 | 7.9 | 9.2 | 8.4 |
| Polyethyleneimine polymer | 5.3 | 5.1 | 6.1 | 5.8 |
| DTPMPA 7Na | 0.6 | 0.4 | 0.8 | 0.6 |
| Ethanol | 3.3 | 3.8 | 2.4 | 3.3 |
| Soil release polymer | 1.2 | 0.8 | 1.2 | 0.2 |
| Perfume | 2.0 | 1.4 | 1.8 | 0 |
| Enzyme mixture (protease, | 4.2 | 3.5 | 0.5 | 0 |
| mannanase, amylase, | | | | |
| cellulase) | | | | |
| Sodium metabisulfite | 0.1 | 0.1 | 0.1 | 0.1 |
| Dye (optionally tinting dye) | 0.02 | 0.01 | 0.01 | 0.0 |
| Water | 5.08 | 6.09 | 5.69 | 7.44 |
| NTU | | | | 1.6 (1.5)* |
| Hazen | | | | 298 (285)* |
| Absorption 450-800 nm | | | | ≤0.1 (≤0.2)* |

*Values between parentheses with 4 ppm tinting dye (Milliken Liquitint Violet 129)

TABLE 2
Formulations (all quantities in wt. % based on total weight)

| Ingredient | Form. 1 | Form. 2 | Form. 3 | Form. 4 |
|---|---|---|---|---|
| Propylene glycol | 6.6 | 7.2 | 6.1 | 6.7 |
| Glycerol | 10.2 | 9.1 | 12.0 | 11.7 |
| Discoloration inhibitor | 0.3 | 0.4 | 0.2 | 0.3 |
| Linear alkylbenzene | 23.1 | 21.9 | 25.4 | 23.5 |
| sulfonate | | | | |
| C13/15 oxo alcohol | 23.2 | 25.2 | 21.6 | 25.2 |
| having 8 EO | | | | |
| Monoethanolamine for | 6.1 | 6.8 | 6.7 | 6.5 |
| saponification | | | | |
| C12-18 soap | 8.4 | 7.9 | 9.2 | 8.4 |
| Polyethyleneimine polymer | 5.3 | 5.1 | 6.1 | 5.8 |
| DTPMPA 7Na | 0.6 | 0.4 | 0.8 | 0.6 |
| Ethanol | 3.3 | 3.8 | 2.4 | 3.3 |
| Soil release polymer | 1.2 | 0.8 | 1.2 | 0.2 |
| Perfume | 2.0 | 1.4 | 1.8 | 0 |
| Enzyme mixture (protease, | 4.2 | 3.5 | 0.5 | 0 |
| mannanase, amylase, | | | | |
| cellulase) | | | | |
| Sodium metabisulfite | 0.1 | 0.1 | 0.1 | 0.1 |
| Dye (optionally tinting dye) | 0.02 | 0.01 | 0.01 | 0.0 |
| Water | 5.38 | 6.39 | 5.89 | 7.64 |
| NTU | | | | 1.5 (1.4)* |
| Hazen | | | | 169 (156)* |
| Absorption 450-800 nm | | | | ≤0.1 (≤0.2)* |

*Values between parentheses with 4 ppm tinting dye (Milliken Liquitint Violet 129)

Production of a three-chamber portion pouch using the film Kuraray Monosol M8720, 88 μm film thickness in a four-chamber cavity (thermoforming temperature 102° C., sealing temperature 150° C.). In each case 7 g of the formulations 1 to 2 were packaged in a chamber 1 to 2 and 2 g formulation 3 was packaged in the central chamber (table 3: universal detergent; table 4: color detergent). Total weight of liquids: 16 g

TABLE 3
Formulations (all quantities in wt. % based on total weight)

| Ingredient | Form. 1 | Form. 2 | Form. 3 |
|---|---|---|---|
| Propylene glycol | 6.6 | 7.2 | 8.1 |
| Glycerol | 10.2 | 9.1 | 12.0 |
| Optical brightener | 0.6 | 0.7 | 0.4 |
| (stilbene type) | | | |
| Linear alkylbenzene | 23.1 | 21.9 | 25.4 |
| sulfonate | | | |
| C13/15 oxo alcohol | 23.2 | 25.2 | 21.6 |
| having 8 EO | | | |
| Monoethanolamine for | 6.1 | 6.8 | 6.7 |
| saponification | | | |
| C12-18 soap | 8.4 | 7.9 | 9.2 |
| Polyethyleneimine polymer | 5.3 | 5.1 | 6.1 |
| DTPMPA 7Na | 0.6 | 0.4 | 0.8 |
| Soil release polymer | 1.5 | 1.8 | 0.8 |
| Perfume | 2.6 | 2.4 | 0 |
| Enzyme mixture (protease, | 5.5 | 2.1 | 0 |
| mannanase, amylase, | | | |
| cellulase) | | | |
| Sodium metabisulfite | 0.1 | 0.1 | 0.1 |
| Dye (optionally tinting dye) | 0.02 | 0.01 | 0.0 |
| Water | 6.18 | 9.29 | 8.79 |

TABLE 4
Formulations (all quantities in wt. % based on total weight)

| Ingredient | Form. 1 | Form. 2 | Form. 3 |
|---|---|---|---|
| Propylene glycol | 6.6 | 7.2 | 6.1 |
| Glycerol | 10.2 | 9.1 | 12.0 |
| Discoloration inhibitor | 0.5 | 0.3 | 0.6 |
| Linear alkylbenzene | 23.1 | 21.9 | 25.4 |
| sulfonate | | | |
| C13/15 oxo alcohol | 23.2 | 25.2 | 21.6 |
| having 8 EO | | | |
| Monoethanolamine for | 6.1 | 6.8 | 6.7 |
| saponification | | | |
| C12-18 soap | 8.4 | 7.9 | 9.2 |
| Polyethyleneimine polymer | 5.3 | 5.1 | 6.1 |
| DTPMPA 7Na | 0.6 | 0.4 | 0.8 |
| Soil release polymer | 1.2 | 0.8 | 1.2 |
| Perfume | 2.6 | 2.4 | 0 |
| Enzyme mixture (protease, | 5.5 | 2.1 | 0 |
| mannanase, amylase, | | | |
| cellulase) | | | |
| Sodium metabisulfite | 0.1 | 0.1 | 0.1 |
| Dye (optionally tinting dye) | 0.02 | 0.01 | 0.0 |
| Water | 6.58 | 10.69 | 10.01 |

What is claimed is:

1. A detergent product comprising a film pouch having a plurality of pouch chambers, each of which is enclosed by at least one water-soluble film, the pouch chambers being formed by water-soluble films which are interconnected in a sealing plane and being separated from one another by sealing portions located in the sealing plane, and the pouch chambers each being filled with a detergent preparation, a plurality of pouch chambers with the number n≥2 being provided, the pouch chambers being arranged in at least one sectional plane around a common n-fold axis of rotation that is perpendicular to the sectional plane, and at least one central chamber being provided which is arranged in the middle region of the film pouch and is filled with a detergent preparation, and the pouch chambers being arranged around the central chamber,
wherein
the detergent preparation with which the central chamber is filled is transparent and achromatic.

2. The detergent product according to claim 1, wherein the detergent preparation with which the central chamber is filled has a turbidity of <50 NTU.

3. The detergent product according to claim 1, wherein the detergent preparation with which the central chamber is filled has a Hazen Color Index of <310.

4. The detergent product according to claim 1, wherein the detergent preparation with which the central chamber is filled has an absorption <0.20 in the wavelength range >450 to 800 nm.

5. The detergent product according to claim 1, wherein the detergent preparation with which the central chamber is filled
(1) is free of enzymes, opacifiers and/or fragrances; and/or
(2) has a surfactant content >35 wt. % based on the total weight of the preparation, the surfactants comprising combinations of anionic and non-ionic surfactants; and/or
(3) is low-water to water-free and has a water content of less than 18 wt.

6. The detergent product according to claim 1, wherein the detergent preparation with which the central chambers is filled
(1) comprises at least one optical brightener; and/or
(2) comprises at least one blue or violet dye; and/or
(3) comprises at least one antioxidant or color stabilizer.

7. The detergent product according to claim 1, wherein the detergent preparations with which the pouch chambers are filled are colored.

8. The detergent product according to claim 1, wherein
(i) the pouch chambers in the sealing plane have the same bases and wherein the bases are arranged in the sealing plane around a common n-fold axis of rotation that is perpendicular to the sealing plane; and/or
(ii) the film pouch has between 2 and 10 pouch chambers; and/or
(iii) the pouch chambers are arranged in at least one sectional plane around a 3- to 9-fold axis of rotation; and/or
(iv) the pouch chambers are arranged in at least one sectional plane around a central n-fold axis of rotation;
(v) at least two pouch chambers, have the same filling volume and/or the same three-dimensional shape; and/or
(vi) the central chamber is separated from each pouch chamber by a sealing portion and wherein the central chamber is at the same distance from each pouch chamber; and/or
(vii) the minimum width of the sealing portion between a pouch chamber and the central chamber is less than 5 mm; and/or
(viii) the central chamber has a base in the sealing plane and wherein the base has circular symmetry or n-fold rotational symmetry with n as the number of pouch chambers; and/or
(ix) the central chamber has a circular base, polygonal base, or a square, triangular, star-shaped, propeller-shaped or fan-wheel-shaped base.

9. The detergent product according to claim 1, wherein
(i) the pouch chamber has a base in the sealing plane and wherein the base is axially asymmetrical; and/or
(ii) the base is drop-shaped or yin-and-yang-shaped.

10. The detergent product according to claim 1, wherein
(i) a bisector of the base is sinistral or dextral and wherein a sinistral or dextral arrangement of all pouch chambers is provided; and/or
(ii) the width of the base transverse to a bisector of the base and/or the cross-sectional area of the pouch chamber perpendicular to the sealing plane initially increases over a portion of the length of the bisector and decreases after reaching a maximum value.

11. The detergent product according to claim 1, is for treating textiles and/or for cleaning or washing textiles.

12. The detergent product according to claim 2, wherein the detergent preparation has a turbidity of <10 NTU.

13. The detergent product according to claim 3, wherein the detergent preparation has a Hazen Color Index of <250.

14. The detergent product according to claim 4, wherein the detergent preparation has an absorption <0.15 in the wavelength range >450 to 800 nm.

15. The detergent product according to claim 4, wherein the detergent preparation has an absorption <0.10 in the wavelength range >450 to 800 nm.

16. The detergent product according to claim 4, wherein the detergent preparation has an absorption <0.08 in the wavelength range >450 to 800 nm.

17. The detergent product according to claim 4, wherein the detergent preparation has an absorption <0.06 or <0.05 in the wavelength range >450 to 800 nm.

18. The detergent product according to claim 5, wherein the detergent preparation has a surfactant content up to 75 wt. % based on the total weight of the preparation, and has a water content of up to 15 wt. %.

19. The detergent product according to claim 6, wherein the detergent preparation comprises at least one optical brightener in an amount <1 wt. % based on the total weight of the detergent preparation in the central chamber.

20. The detergent product according to claim 6, wherein the detergent preparation comprises at least one blue or violet dye, in an amount <0.1 wt. % based on the total weight of the detergent preparation in the central chamber.

21. The detergent product according to claim 6, wherein the detergent preparation comprises at least one antioxidant or color stabilizer, in an amount <0.5 wt. % based on the total weight of the detergent preparation in the central chamber.
